(19) United States
(12) Patent Application Publication
(10) Pub. No.: US 2024/0346109 A1
(43) Pub. Date: Oct. 17, 2024

(54) OPERATION CONVERSION METHOD FOR NEURAL NETWORK, METHOD OF PERFORMING MATRIX MULTIPLICATION OPERATION BASED ON CONVOLUTION OPERATION, AND INTELLIGENCE PROCESSING UNIT

(71) Applicant: SigmaStar Technology Ltd., Xiamen (CN)

(72) Inventor: Yu Xia, Shanghai (CN)

(21) Appl. No.: 18/427,864

(22) Filed: Jan. 31, 2024

(30) Foreign Application Priority Data
Apr. 17, 2023 (CN) 202310405421.1

(51) Int. Cl. G06F 17/16; G06F 7/76; G06F 17/15

(52) U.S. Cl. CPC G06F 17/16; G06F 7/76; G06F 17/15

(57) ABSTRACT

A method of performing a matrix multiplication operation based on a convolution operation includes the following steps: (A) reading a first data from a first storage device and storing the first data in a second storage device; (B) reading a second data from the first storage device and storing the second data in the second storage device; (C) performing the convolution operation on the first data and the second data to obtain a first result; and (D) storing the first result in the first storage device. The first result is equal to a second result obtained by performing the matrix multiplication operation on the first data and the second data.

This application claims the benefit of China application Serial No. 202310405421.1, filed on Apr. 17, 2023, the subject matter of which is incorporated herein by reference.

### BACKGROUND OF THE INVENTION

### 1. Field of the Invention

The present invention generally relates to matrix multiplication operations, and, more particularly, to methods and devices for implementing matrix multiplication operations based on convolution operations.

### 2. Description of Related Art

Reference is made to FIG. 1, which shows a schematic diagram of a matrix multiplication. The matrix multiplication operator multiplies the matrix ML and the matrix MR to obtain the matrix product MO(i.e., ML·MR=MO). The matrix ML and the matrix MR are the two operands of the matrix multiplication operator. The number of rows rr of the matrix ML is row_L (which is 5), and the number of columns cc of the matrix ML is col_L (which is 1). The number of rows rr of the matrix MR is row_R (which is 1), and the number of columns cc of the matrix MR is col_R (which is 5). Therefore, the matrix product MO is a matrix of row_L×col_R (which is 5×5). The value of each entry of the matrix product MO(MO(rr,cc)) is MO(1,1)=a1b1, MO(1,2)=a1b2, . . . , MO(2,1)=a2b1, . . . , and so on.

There are a large number of matrix multiplication operators in a transform neural network. However, for an electronic device that does not implement a matrix multiplication acceleration circuit, a large number of matrix multiplications is a burden on the electronic device, degrading the user experience and reducing the performance of the electronic device.

### SUMMARY OF THE INVENTION

In view of the issues of the prior art, an object of the present invention is to provide an operation conversion method, a matrix multiplication operation method based on convolution operations, and an intelligence processing unit (IPU) for neural networks, so as to make an improvement to the prior art.

According to one aspect of the present invention, an operation conversion method for a neural network is provided. The operation conversion method converts a matrix multiplication operation into a convolution operation and includes the following steps: (A) obtaining a first operand and a second operand of the matrix multiplication operation from a storage device; (B) determining a third dimensional information of a third operand based on a first dimensional information of the first operand; (C) determining a fourth dimensional information of a fourth operand based on a second dimensional information of the second operand; (D) setting a bias parameter and a scale parameter; (E) generating a convolution operator based on the third dimensional information, the fourth dimensional information, the bias parameter, and the scale parameter; and (F) storing the convolution operator in the storage device. The convolution operator performs the convolution operation on the third operand and the fourth operand, and a result of the convolution operation on the third operand and the fourth operand is substantially equal to a result of the matrix multiplication operation on the first operand and the second operand.

According to another aspect of the present invention, a method of performing a matrix multiplication operation based on a convolution operation is provided. The method includes the following steps: (A) reading a first data from a first storage device and storing the first data in a second storage device; (B) reading a second data from the first storage device and storing the second data in the second storage device; (C) performing the convolution operation on the first data and the second data to obtain a first result; and (D) storing the first result in the first storage device. The first result is equal to a second result obtained by performing the matrix multiplication operation on the first data and the second data.

According to still another aspect of the present invention, an IPU is provided. The IPU is coupled to a first storage device and includes a second storage device, a direct memory access (DMA) circuit, and a computing circuit. The DMA circuit is coupled to the second storage device and configured to perform following steps: (A) reading a first data from the first storage device and storing the first data in the second storage device; and (B) reading a second data from the first storage device and storing the second data in the second storage device. The computing circuit is coupled to the second storage device and configured to perform following steps: (C) performing a convolution operation on the first data and the second data to obtain a first result. The DMA circuit further stores the first result in the first storage device, and the first result is equal to a second result obtained by performing a matrix multiplication operation on the first data and the second data.

The technical means embodied in the embodiments of the present invention can solve at least one of the problems of the prior art. Therefore, compared to the prior art, the present invention can improve the performance of electronic devices.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 shows a schematic diagram of a matrix multiplication.

FIG. 2 shows a schematic diagram of using convolution operations to implement matrix multiplications according to the present invention.

FIG. 3 is a flowchart of an operation conversion method of a neural network according to an embodiment of the present invention.

FIG. 4 is a functional block diagram of an operation conversion device according to an embodiment of the present invention.

FIG. 5 is a schematic diagram of data rearrangement according to another embodiment of the present invention.

FIG. 6 is a flowchart of an operation conversion method of a neural network according to another embodiment of the present invention.

FIG. 7 is a functional block diagram of an electronic device according to an embodiment of the present invention.

FIG. 8 is a flowchart of a method of performing a matrix multiplication operation based on a convolution operation according to an embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an operation conversion method for neural network, a method of performing a matrix multiplication operation based on a convolution operation, and an intelligence processing unit (IPU). On account of that some or all elements of the IPU could be known, the detail of such elements is omitted provided that such detail has little to do with the features of this disclosure, and that this omission nowhere dissatisfies the specification and enablement requirements. Some or all of the processes of the method of performing a matrix multiplication operation based on a convolution operation may be implemented by software and/or firmware and can be performed by the IPU or its equivalent. A person having ordinary skill in the art can choose components or steps equivalent to those described in this specification to carry out the present invention, which means that the scope of this invention is not limited to the embodiments in the specification.

Since the convolutional neural network is one of the neural networks commonly used today, the present invention provides an electronic device and method for performing a matrix multiplication operation based on convolution operations.

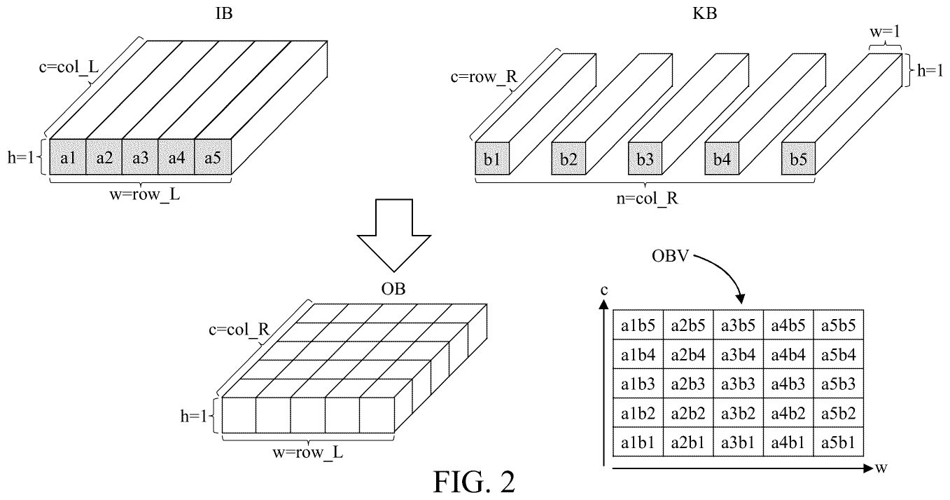

Reference is made to FIG. 2, which shows a schematic diagram of performing a matrix multiplication based on convolution operations according to the present invention. The input data IB and the input data KB are the two operands of a 2-dimensional (2D) convolution operator. For example, the input data IB may be a tensor or a part of a tensor (e.g., a tile), and the input data KB may be the convolution kernel corresponding to the input data IB.

The dimensional information of the input data IB is as follows: the batch number (n) is 1, the height (h) is 1, the width (w) is row_L (which is 5), and the channel (c) is col_L (which is 1).

The dimensional information of the input data KB is as follows: the batch number (n) is col_R (which is 5) (i.e., the input data KB contains 5 blocks, each corresponding to a convolution kernel), the height (h) is 1, the width (w) is 1, and the channel (c) is row_R.

The dimensional information of the result OB of the convolution operation is as follows: the batch number (n) is 1, the depth (d) is 1, the height (h) is 1, the width (w) is row_L, and the channel (c) is col_R.

The table OBV shows the value of each small block of the result OB of the convolution operation (OB(w,c)). More specifically, OB(1,1)=a1b1, OB(1,2)=a1b2, . . . , OB(2,1)=a2b1, . . . , and so on.

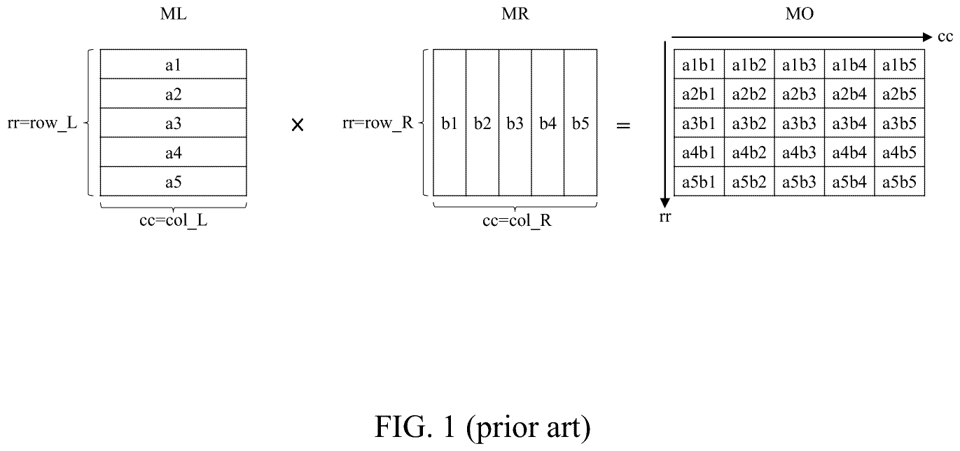

Reference is made to both FIG. 1 and FIG. 2. Since OB(x,y)=MO(x,y) (x and y are positive integers), the convolution operation can be used to perform matrix multiplication. In some embodiments, in the convolution operation, the bias parameter can be set to 0 and the scale parameter can be set to 1.

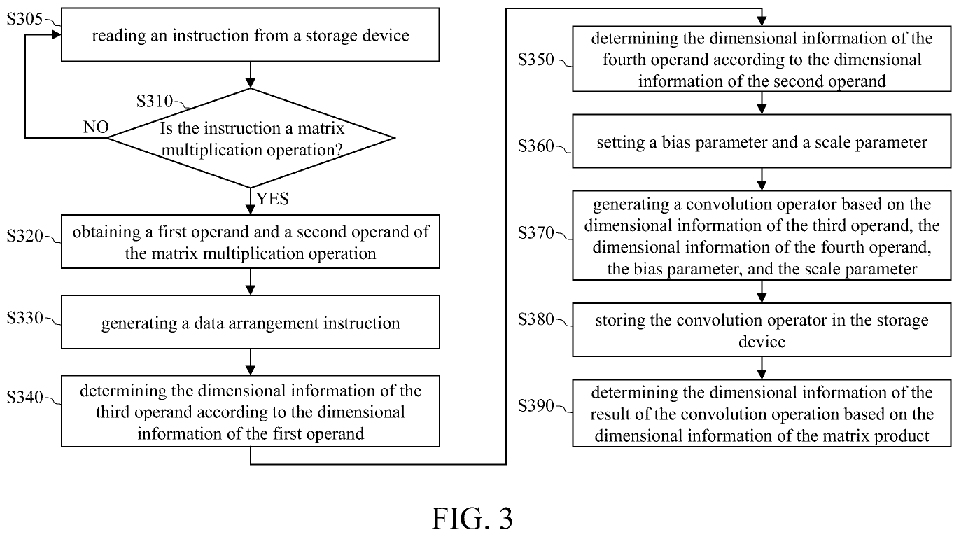

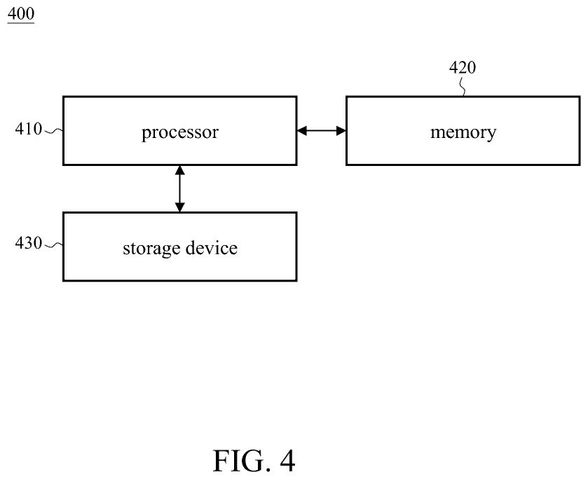

Reference is made to FIG. 3, which is a flowchart of an operation conversion method of a neural network according to an embodiment of the present invention. The operation conversion method is used to convert a matrix multiplication operator into a convolution operator. Reference is made to FIG. 4, which is a functional block diagram of an operation conversion device according to an embodiment of the present invention. The operation conversion device 400 includes a processor 410 (e.g., a central processing unit (CPU), a microprocessor, a microprocessing unit), a memory 420 (which may be a volatile memory, such as a dynamic random access memory (DRAM)), and a storage device 430 (which may be a volatile memory or non-volatile memory, such as DRAM, flash memory, or hard disk). The memory 420 stores a plurality of program codes. The storage device 430 stores a plurality of instructions of a neural network, some of the instructions being associated with matrix multiplication. By executing the program codes in the memory 420, the processor 410 performs the process of FIG. 3 to convert a matrix multiplication operation (matrix multiplication operator) into a convolution operation (convolution operator). The operation conversion device 400 may be a general-purpose computer, or a computer dedicated to implementing the operation conversion method. FIG. 3 includes the following steps.

Step S305: The processor 410 reads an instruction of the neural network from the storage device 430.

Step S310: The processor 410 determines whether the instruction is a matrix multiplication operation. If YES, the processor 410 performs step S320; otherwise, the processor 410 performs step S305 to read the next instruction.

Step S320: The processor 410 obtains a first operand and a second operand of the matrix multiplication operation. Taking FIG. 1 as an example, in this step, the processor 410 obtains the matrix MR (the first operand) and the matrix ML (the second operand) from the storage device 430.

Step S330: The processor 410 generates a data arrangement instruction which is used to rearrange the data of the first operand. Due to the nature of the convolution operation, it is necessary to rearrange the data (i.e., entries) of the right matrix (i.e., the matrix MR) of the original matrix multiplication (ML: MR). For example, with reference to FIG. 1 and FIG. 2, there is no data rearrangement between the matrix ML and the input data IB, but the input data KB is the result of a data rearrangement of the matrix MR. More specifically, the first column of the matrix MR corresponds to the block whose batch number (n) in the input data KB is 1, the second column of the matrix MR corresponds to the block whose batch number (n) in the input data KB is 2, and so on.

For a matrix, rearranging the data of the matrix is the same as or equivalent to performing a transposition operation on the matrix. The details of the matrix transposition operation are well known to people having ordinary skill in the art and therefore are omitted for brevity.

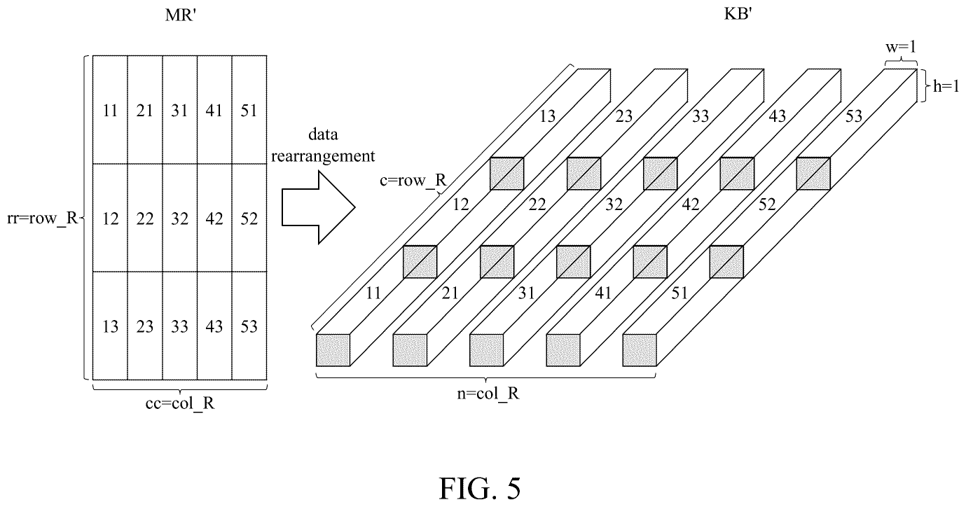

Reference is made to FIG. 5, which is a schematic diagram of data rearrangement according to another embodiment of the present invention. The matrix MR′ becomes the input data KB′ after data rearrangement. The batch number (n) of the input data KB′ is col_R (which is 5), and the channel (c) of the input data KB′ is row_R (which is 3). For comparison purposes, if there were no data rearrangement, the batch number (n), the width (w), and the channel (c) of the input data corresponding to the matrix MR′ would be 1, row_R (which is 3), and col_R (which is 5) respectively.

Continue with FIG. 3.

Step S340: The processor 410 determines the dimensional information of the input data KB (the third operand, that is, one of the operands of the convolution operation) according to the dimensional information of the matrix MR (the first operand). This step is the same as or equivalent to the reshaping operation of the convolution operation. For example, the dimensional information of the matrix MR in FIG. 1 is row_R×col_R=1×5, while the dimensional information of the input data KB in FIG. 2 is (w,h,n,c)=(1,1,col_R,row_R)=(1,1,5,1). The convolution operation will process the input data KB (the third operand) according to its dimensional information. That is to say, the dimensional information of the input data KB determines how the convolution operation treats or processes the input data KB.

Step S350: The processor 410 determines the dimensional information of the input data IB (the fourth operand, that is, another operand of the convolution operation) based on the dimensional information of the matrix ML (the second operand). Similarly, this step is the same as or equivalent to the reshaping operation of the convolution operation. For example, the dimensional information of the matrix ML in FIG. 1 is row_L×col_L=5×1, while the dimensional information of the input data IB in FIG. 2 is (w,h,n,c)=(row_L,1,1,col_L)=(5,1,1,1). The convolution operation will process the input data IB (the fourth operand) according to its dimensional information. That is to say, the dimensional information of the input data IB determines how the convolution operation treats or processes the input data IB.

The result of the convolution operation is associated with the dimensional information of the input data. When the convolution operation instruction contains the arranged dimensional information, the result of the convolution operation is the same or substantially the same as the result of the matrix multiplication as expected.

Step S360: The processor 410 sets a bias parameter and a scale parameter. More specifically, the processor 410 sets the bias parameter to 0 and the scale parameter to 1.

Step S370: The processor 410 generates a convolution operator based on the dimensional information of the input data KB (the third operand), the dimensional information of the input data IB (the fourth operand), the bias parameter, and the scale parameter. This convolution operator is used to replace the above matrix multiplication operation. More specifically, the input data IB and the input data KB are the operands of the convolution operator, and the result OB of the convolution operation is the same or substantially the same as the result (the matrix product MO) of the matrix multiplication operation.

Step S380: The processor 410 stores the convolution operator in the storage device 430. In practice, the convolution operator may be stored in the storage device 430 in the form of a convolution operation instruction.

Step S390: The processor 410 determines the dimensional information of the result OB of the convolution operation based on the dimensional information of the result (i.e., the matrix product MO) of the matrix multiplication operation. This step is the same as or equivalent to the reshaping operation of the convolution operation, so that subsequent instructions or operations can treat the result OB of the convolution operation as a matrix (2-dimensional data).

In some embodiments, after step S390 finishes, the processor 410 continues to perform step S305. That is, the processor 410 scans the storage device 430 to check each instruction.

Note that because the convolution operation satisfies the commutative property (i.e., IB*KB=KB*IB), in an alternative embodiment, the input data KB may correspond to the matrix ML, and the input data IB may correspond to the matrix MR (i.e., the input data IB is the data of the matrix MR after data rearrangement).

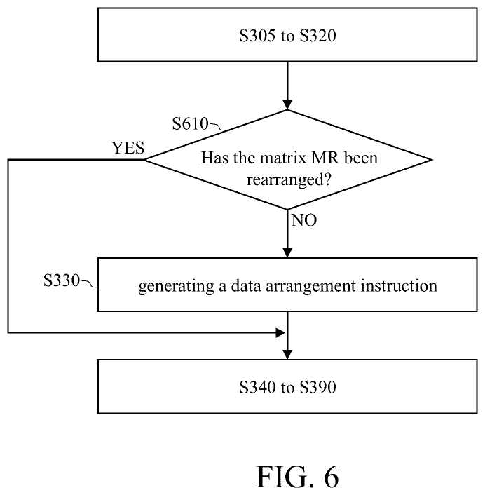

Reference is made to FIG. 6, which is a flowchart of an operation conversion method of a neural network according to another embodiment of the present invention. FIG. 6 is similar to FIG. 3, except that in the embodiment of FIG. 6, prior to step S330, the processor 410 determines whether the matrix MR has been rearranged (step S610). More specifically, in an overall operation including the matrix multiplication operation (i.e., ML: MR=MO), if the matrix MR has been rearranged before the matrix multiplication operation, step S330 can be skipped.

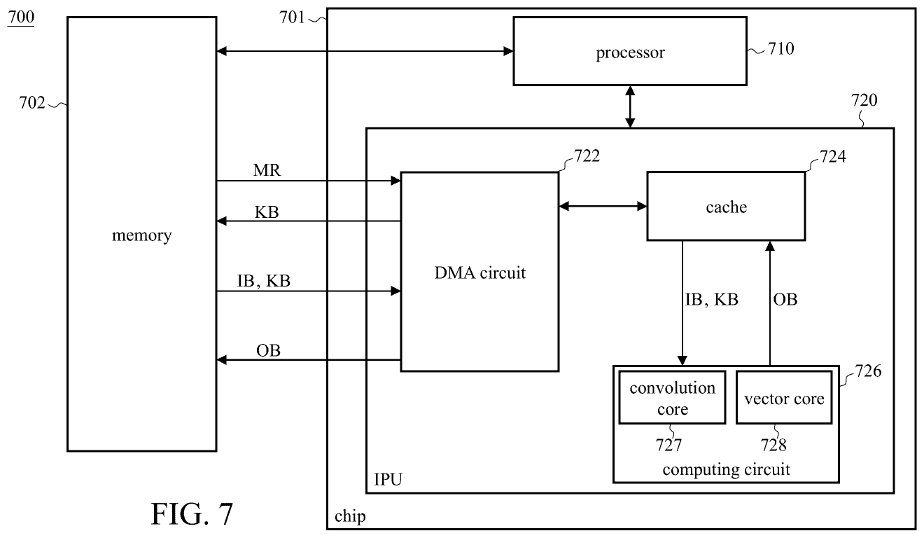

Reference is made to FIG. 7, which is a functional block diagram of the electronic device according to an embodiment of the present invention. The electronic device 700 can perform the aforementioned convolution operation. The electronic device 700 includes a chip 701 and a memory 702. The memory 702 is a type of storage device (which may be a volatile memory (e.g., DRAM)). The chip 701 may be a chip with specific functions (e.g., an image processing chip) and includes a processor 710 and an IPU 720. The processor 710 can be a circuit or electronic component with program execution capabilities, such as a CPU, a microprocessor, a microprocessing unit, a digital signal processor (DSP), an application specific integrated circuit (ASIC), or their equivalents. In some cases, the processor 710 cooperates with the IPU 720 to implement the functions of the chip 701. More specifically, the processor 710 sends instructions (e.g., instructions associated with convolution operations or vector operations) to the IPU 720, and the IPU 720 executes the instructions.

The IPU 720 includes a direct memory access (DMA) circuit 722, a cache 724 (which is a type of storage device), and a computing circuit 726. The computing circuit 726 includes a convolution core 727 and a vector core 728. The convolution core 727 is used to perform convolution operations, and the vector core 728 is used to perform vector operations.

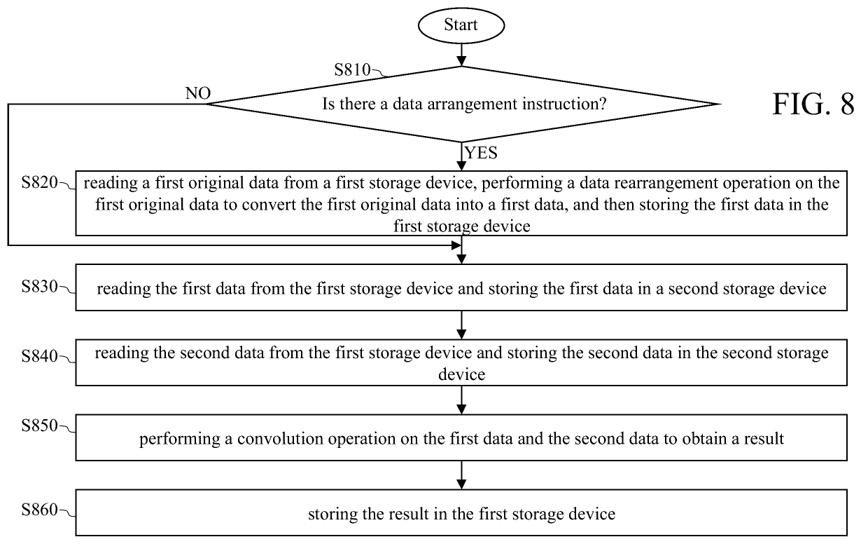

Reference is made to FIG. 8, which is a flowchart of a method of performing a matrix multiplication operation based on a convolution operation according to an embodiment of the present invention. The flow of FIG. 8 may be executed by the electronic device 700 (more specifically, the chip 701) of FIG. 7 and includes the following steps. It is assumed here that the following convolution operation corresponds to the matrix multiplication operation of ML. MR (with reference to FIG. 1). Note that unlike convolution operations, matrix multiplication operations do not satisfy the commutative property (i.e., ML·MR≠MR·ML).

Step S810: The processor 710 determines whether there is a data arrangement instruction. If YES (i.e., step S330 in FIG. 3 or FIG. 6 has been performed by the operation conversion device 400), the processor 710 controls the IPU 720 to perform step S820; otherwise, the processor 710 controls the IPU 720 to perform steps S830 to S860. The absence of a data arrangement instruction means that the data of the matrix multiplication operation has already been rearranged in advance. In a specific embodiment, when the data of the matrix multiplication operation, such as the matrix MR, is a constant value, the data is rearranged in advance, and the rearranged data is stored in the storage device.

Step S820: The DMA circuit 722 reads the first original data (e.g., the matrix MR) from the first storage device (e.g., the memory 702), performs a data rearrangement operation on the first original data to convert the first original data into a first data (e.g., the input data KB, that is, the convolution kernel of the subsequent convolution operation), and then stores the first data in the first storage device. More specifically, the DMA circuit 722 performs the data rearrangement operation on the first original data by writing and reading the first original data to and from the cache 724. This data rearrangement operation is equivalent to the transposition operation in matrix operations. Then, the DMA circuit 722 writes the first data back to the first storage device.

Step S830: The DMA circuit 722 reads the first data (e.g., the input data KB) from the first storage device and stores the first data in a second storage device (e.g., the cache 724). Note that no data arrangement instruction (i.e., the result of step S810 is NO) indicates that the first original data has already been arranged in the format of the input data of the convolution operation (e.g., the format of the input data KB). Note that the first data is not rearranged in step S830.

Step S840: The DMA circuit 722 reads the second data (e.g., the input data IB, which is substantially the same as the matrix ML) from the first storage device and stores the second data in the second storage device. Note that the second data is not rearranged in step S840.

Step S850: The computing circuit 726 (more specifically, the convolution core 727) performs the convolution operation on the first data and the second data to obtain a result (e.g., the result OB of the convolution operation) and stores the result in the second storage device. In some embodiments, the bias parameter and the scale parameter of the convolution operation are 0 and 1 respectively. In some embodiments, the bias parameters and the scale parameters are stored in the memory 702 in advance, and the IPU 720 reads the parameters from the memory 702 and performs corresponding settings.

Step S860: The DMA circuit 722 stores the result in the first storage device for the chip 701 to perform other subsequent operations.

As discussed above, because the instructions executed by the chip 701 have been processed in advance, the result of the convolution operation performed by the chip 701 is equivalent to the result of matrix multiplication (e.g., with reference to FIGS. 1 and 2, the result OB of the convolution operation is equal or substantially equal to the matrix product MO).

In summary, even if an electronic device does not implement a matrix multiplication acceleration circuit, the matrix multiplication operation can still be accelerated using the present invention, thereby improving performance and user experience.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An operation conversion method for a neural network for converting a matrix multiplication operation into a convolution operation, the operation conversion method comprising:
(A) obtaining a first operand and a second operand of the matrix multiplication operation from a storage device;
(B) determining a third dimensional information of a third operand based on a first dimensional information of the first operand;
(C) determining a fourth dimensional information of a fourth operand based on a second dimensional information of the second operand;
(D) setting a bias parameter and a scale parameter;
(E) generating a convolution operator based on the third dimensional information, the fourth dimensional information, the bias parameter, and the scale parameter; and
(F) storing the convolution operator in the storage device;
wherein the convolution operator performs the convolution operation on the third operand and the fourth operand, and a result of the convolution operation on the third operand and the fourth operand is substantially equal to a result of the matrix multiplication operation on the first operand and the second operand.

2. The operation conversion method of claim 1, wherein the matrix multiplication operation generates a first result, and the convolution operator generates a second result, the operation conversion method further comprising:
(G) determining a fifth dimensional information of the second result based on a sixth dimensional information of the first result.

3. The operation conversion method of claim 1 further comprising:
generating a data arrangement instruction prior to step (B), the data arrangement instruction being used to rearrange the first operand.

4. The operation conversion method of claim 3, wherein the first operand is a matrix, and the data arrangement instruction is equivalent to performing a transposition operation on the matrix.

5. The operation conversion method of claim 3, wherein the third operand is a convolution kernel of the convolution operation.

6. The operation conversion method of claim 1, wherein the first operand is a matrix A, the second operand is a matrix B, and the matrix multiplication operation calculates B·A, the operation conversion method further comprising:
generating a data arrangement instruction prior to step (B), the data arrangement instruction being used to rearrange data of the matrix A.

7. A method of performing a matrix multiplication operation based on a convolution operation, comprising:
(A) reading a first data from a first storage device and storing the first data in a second storage device;
(B) reading a second data from the first storage device and storing the second data in the second storage device;
(C) performing the convolution operation on the first data and the second data to obtain a first result; and
(D) storing the first result in the first storage device;
wherein the first result is equal to a second result obtained by performing the matrix multiplication operation on the first data and the second data.

8. The method of claim 7 further comprising:
(E) prior to step (A), reading a first original data from the first storage device, performing a data rearrangement operation on the first original data to convert the first original data into the first data, and storing the first data in the first storage device.

9. The method of claim 8, wherein the first original data is a matrix, and the data rearrangement operation is equivalent to performing a transposition operation on the matrix.

10. The method of claim 8, wherein the first data is a convolution kernel of the convolution operation.

11. The method of claim 7, wherein the first data is a matrix A, the second data is a matrix B, and the matrix multiplication operation calculates B·A, the method further comprising:
(E) prior to step (A), reading the matrix A from the first storage device, performing a data rearrangement operation on the matrix A, and then storing the rearranged matrix A in the first storage device.

12. The method of claim 7, wherein a bias parameter of the convolution operation is zero, and a scale parameter of the convolution operation is one.

13. An intelligence processing unit (IPU) coupled to a first storage device, the IPU comprising:
a second storage device;
a direct memory access (DMA) circuit coupled to the second storage device and configured to perform following steps:
(A) reading a first data from the first storage device and storing the first data in the second storage device; and
(B) reading a second data from the first storage device and storing the second data in the second storage device; and
a computing circuit coupled to the second storage device and configured to perform following steps:
(C) performing a convolution operation on the first data and the second data to obtain a first result;
wherein the DMA circuit further stores the first result in the first storage device, and the first result is equal to a second result obtained by performing a matrix multiplication operation on the first data and the second data.

14. The IPU of claim 13, wherein the DMA circuit is further configured to perform following steps:
(D) prior to step (A), reading a first original data from the first storage device, performing a data rearrangement operation on the first original data to convert the first original data into the first data, and storing the first data in the first storage device.

15. The IPU of claim 14, wherein the first original data is a matrix, and the data rearrangement operation is equivalent to performing a transposition operation on the matrix.

16. The IPU of claim 14, wherein the first data is a convolution kernel of the convolution operation.

17. The IPU of claim 13, wherein the first data is a matrix A, the second data is a matrix B, the matrix multiplication operation calculates B·A, and the DMA circuit is further configured to perform following steps:
(D) prior to step (A), reading the matrix A from the first storage device, performing a data rearrangement operation on the matrix A, and then storing the rearranged matrix A in the first storage device.
